(19) United States
(12) Patent Application Publication
(10) Pub. No.: US 2016/0154468 A1
(43) Pub. Date: Jun. 2, 2016

(54) Intraoral User Interface

(71) Applicant: Dustin Ryan Kimmel, San Francisco, CA (US)

(72) Inventor: Dustin Ryan Kimmel, San Francisco, CA (US)

(21) Appl. No.: 14/985,512

(22) Filed: Dec. 31, 2015

Related U.S. Application Data
(63) Continuation-in-part of application No. 14/817,072, filed on Aug. 3, 2015.
Application No. 14/817,072 is a continuation-in-part of application No. 13/831,940, filed on Mar. 15, 2013, now Pat. No. 9,117,363.
(60) Provisional application No. 61/612,398, filed on Mar. 19, 2012.

(51) Int. Cl. G06F 3/01; A61C 8/00; A61C 19/00

(52) U.S. Cl. CPC G06F 3/017; A61C 19/00; A61C 8/0093

(57) ABSTRACT

Methods, apparatuses, systems, and computer-readable media for providing a user interface for communicating via an electronic device for use in an oral cavity of an animal and resistant to damage from bodily fluids and pressure. The device may include: a power device, which can power the apparatus, a memory storage device, which can store and recall data; a communications subsystem, which communicates with one or more remote devices; an output device, which creates stimulus directly or indirectly observable in the mouth environment; an input device, which can create signals according to activity in the mouth environment and can send them to the memory storage device and/or processor; and a processor coupled to the memory storage device, the communication subsystem, the output device and the input device.

### CROSS-REFERENCE TO RELATED APPLICATIONS

The present application is a continuation-in-part application of co-pending U.S. Non-provisional patent application Ser. No. 14/817,072 filed on Aug. 3, 2015, and entitled “Crowdsourcing Intraoral Information,” that is a continuation-in-part of U.S. Non-provisional patent application Ser. No. 13/831,940 filed Mar. 15, 2013, and entitled “Intraoral Processing and Communications Device” that claims priority and benefit from U.S. Provisional Patent Application Ser. No. 61/612,398 filed Mar. 19, 2012, and is entitled “Intraoral Processing and Communications Device,” which are incorporated by reference herein in their entirety for all purposes.

### BACKGROUND

Aspects of the disclosure relate to computing technologies. In particular, aspects of the disclosure relate to mobile computing device technologies, such as systems, methods, apparatuses, and computer-readable media of oral or intraoral computing and communications technology.

In anatomy, the area known as “the mouth” is a nexus of biological processes, and can be capable of great sensation, dexterity, and communication—abilities that could be used for fine control, interaction, and exchange of information. However, its harsh, dynamic and vulnerable environment makes presenting a user interface to, and maintaining direct, prolonged access to the abilities and perspective of the mouth a difficulty.

Mouth-activated communications devices and orally-disposed controllers can be connected to and used to control such devices as wheelchairs, computers, and text-to-speech devices, and the like. This communication typically happens through a wired connection. These mouth-activated communications devices are limiting in their ability to connect without cumbersome wires. These mouth-activated communications devices are also limiting in their ability to be integrated with and used as part of an everyday life and/or lifestyle, as they block and/or hinder normal body functions and operation such as eating, talking, breathing, etc. These devices are also limiting in that they engage and/or occupy the user's tongue outside the range of its normal activities in actions for input. Mouth-activated communications devices are also limiting in that they are not based on the tongue, so they can't make use of the tongue-centric perspective, data, and/or capabilities (like the ability to track motions of the tongue from the perspective of the tongue (such as orientation during speech) and the input that can be gathered from this perspective, the shape-changing abilities of the tongue around a piercing, the range of sensory and control capabilities of the full tongue (as opposed to just the tip of the tongue) the dexterity of the tongue (such as rotation, curling, etc.), and/or the ability of the tongue to be split into two independently mobile halves), can't be combined in multiple instances on the tongue and/or other areas of the mouth.

Orally-disposed communications devices and mouth-activated controllers can often be linked to other devices, however their functionality is usually limited to sending data to these other devices for control or logging purposes, wherein no feedback or dynamic oral user interface is communicated to or communicates with the wearer. These orally-disposed communications devices and mouth-activated controllers are limiting in their lack of delivery of feedback of a user interface or information about the controlled device to the user. Accordingly, further advances in intraoral processing and communications devices have been needed.

Embodiments of the invention help solve these and other problems.

### SUMMARY

The invention is a mobile processing and communications device, that can be wielded directly from the mouth. A user, wielding the device from the mouth, can observe the device's dynamic oral user interface, and, using this interface, can control the device and/or wirelessly communicate with other devices.

An embodiment of the present disclosure relates to an electronic device having an apparatus which includes a housing for use in a mouth environment of an animal and resistant to damage from bodily fluids and pressure. The housing can be pierced through a tongue, a lip, or a cheek, anchored to a tooth or a teeth of the mandible, or implanted in (or attached to an implant in) the maxilla or mandible. The housing includes: a power device, which can power the apparatus, a memory storage device, which can store and recall data; a communications subsystem, which communicates with one or more remote devices; an output device, which creates stimulus directly or indirectly observable in the mouth environment; an input device, which can create signals according to activity in the mouth environment and can send them to the memory storage device and/or processor; and a processor coupled to the memory storage device, the communication subsystem, the output device and the input device. An advantage of the present invention is that it is more effective in harnessing the communicative power of the tongue than current inventions.

The housing can be one or more of a piercing jewelry, a piercing stud, a mandible retainer, a mandible bridge, a dental implant and an attachable to a dental implant. The piercing jewelry can be a barbell shape. The piercing jewelry housing is advantageous because it allows the user to wield the device from and/or with the tongue; this allows the device greater contact with the dexterity and perceptive power of the tongue, as well as locating it within a nexus of life processes. The mandible retainer and/or bridge is advantageous because it allows the user to wield the device from the lower jaw with the tongue in a relaxed, forward position (instead of reaching up into the maxilla). The dental implant housing is advantageous as it can be put in place for many years, perhaps permanently, and (if replacing a tooth) takes up no extra room in the mouth environment. The dental implant housing is also advantageous because it allows stimulation of deeper gum tissue.

The electronic device further includes a power device deriving power from one or more of energy of an internal battery, wireless energy transfer, energy from chemical or electrical reactions with the surrounding mouth environment, energy from chemical reactions with the blood of the user, energy from the physical flow of the bloodstream of the user, and kinetic energy of the motion of the animal.

The electronic device can further include a communications device that can be one or more of an EMF transmitter/receiver device, a Radio Frequency Identification (RFID) tag, a Bluetooth device, a WiFi device, and a cellular device.

The electronic device can further include an output device that can be one or more of a mechanical wave generator device, an electrical stimulator device, a vibration device, and a physical release device.

The electronic device can further include an input device that can be one or more of a touch sensor device, a material sensor device, a pressure sensor device, a movement tracking sensor device, an orientation sensor device, an acceleration sensor device, a temperature sensor device, an air sensor device, and a light sensor device.

The electronic device can further include a memory storage device that can include one or more application programs.

Another embodiment of the present disclosure relates to an electronic device having an apparatus including a housing inside the mouth of an animal and resistant to damage from bodily fluids and pressure. The housing can be one of a tongue piercing, a lip piercing, and a cheek piercing. The housing can further include: a power device for powering the apparatus; a processor communicatively coupled to an output device, input device, memory storage device, and communications subsystem. The output device can generate one or more stimuli in the mouth environment. The input device can create signals associated with the analog input in the mouth. The memory storage device can be communicatively coupled to the processor for storing and recalling data. The communications subsystem can communicate with one or more remote devices. The housing can include a piercing jewelry of barbell shape. The barbell shape is advantageous because it allows the housing to stay in the tongue but still to rotate in its piercing site.

The electronic device can further includes a power device which can derive power from the energy of an internal battery.

The electronic device can further include a communications device which can include an EMF transmitter/receiver device.

The electronic device can further include an output device includes one or more of a mechanical wave generator device, an electrical stimulator device, a vibration device, and a physical release device.

The electronic device can further include an input device which can include one or more of a touch sensor device, a pressure sensor device, a movement tracking sensor device, an orientation sensor device, an acceleration sensor device, a temperature sensor device, an air sensor device, and a light sensor device.

The electronic device can further include a memory storage device that can include one or more application programs.

An example method for communicating includes generating a stimulus to a tongue of a user to communicate a user interface to the user; detecting an analog input from an environment of the tongue of the user; and interpreting the analog input from the environment as one or more user commands.

In certain embodiments the stimulus can be generated using a tongue-pierced device.

In certain embodiments the stimulus can be generated using a device anchored to a tooth or a teeth of the mandible.

In certain embodiments the stimulus can be generated using a device implanted in (or attached to an implant in) the maxilla or mandible.

In certain embodiments the stimulus can be generated by one or more of creating vibration, causing electric shocks from electrodes, and dispensing matter.

In certain embodiments the analog input can be detected from one or more of sensing touch, orientation, acceleration, pressure, and sound at the environment of the tongue.

In an example non-transitory computer readable storage medium, wherein the non-transitory computer readable storage medium comprises instructions executable by a processor, the instructions comprising instructions to generate a stimulus to a tongue of a user to communicate a user interface to the user; detect an analog input from an environment of the tongue of the user, and interpret the analog input from the environment as one or more user commands.

In one implementation of the non-transitory computer readable storage medium the stimulus can be generated using a tongue-pierced device.

In another implementation of the non-transitory computer readable storage medium the stimulus can be generated using a device anchored to a tooth or a teeth of the mandible.

In another implementation of the non-transitory computer readable storage medium the stimulus can be generated using a device implanted in (or attached to an implant in) the maxilla or mandible.

In another implementation of the non-transitory computer readable storage medium the stimulus can be generated by one or more of creating vibration, causing electric shocks from electrodes, and dispensing matter.

In another implementation of the non-transitory computer readable storage medium the analog input can be detected from one or more of sensing touch, orientation, acceleration, pressure, and sound at the environment of the tongue.

An example device or apparatus for communicating includes means for generating a stimulus to a tongue of a user to communicate a user interface to the user, means for detecting an analog input from an environment of the tongue of the user, and means for interpreting the analog input from the environment as one or more user commands.

In certain embodiments the device or apparatus can include means for generating the stimulus using a tongue-pierced device.

In certain embodiments the device or apparatus can include means for generating the stimulus using a device anchored to a tooth or a teeth of the mandible.

In certain embodiments the device or apparatus can include means for generating the stimulus using a device implanted in (or attached to an implant in) the maxilla or mandible.

In certain embodiments the device or apparatus can include means for generating the stimulus by causing vibration, causing electric shocks from electrodes, and dispensing matter.

In certain embodiments the device or apparatus can include means for detecting the analog input from one or more of sensing touch, orientation, acceleration, pressure, and sound at the environment of the tongue.

The foregoing has outlined rather broadly the features and technical advantages of examples according to the disclosure in order for the detailed description that follows to be better understood. Additional features and advantages will be described hereinafter. The conception and specific examples disclosed can be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

A further understanding of the nature and advantages of examples provided by the disclosure can be realized by reference to the remaining portions of the specification and the drawings, wherein like reference numerals are used throughout the several drawings to refer to similar components. In some instances, a sub-label may be associated with a reference numeral to denote one of multiple similar components.

FIG. 1 illustrates an example device in which one or more aspects of the disclosure may be implemented,

FIG. 2 illustrates a perspective view of an embodiment of the device, a barbell-shaped stud that can be worn embedded in or pierced through mouth tissue.

FIG. 3 is a perspective view of a cross section of a human head, showing the positioning of the device as embodied in FIG. 2.

FIG. 4 is a perspective view of a tooth-implant embodiment of the device.

FIG. 5 is a perspective view of the teeth, gums and tongue of a human mouth, showing the position of the device as embodied in FIG. 4.

FIG. 6 is a perspective view of a dental bridge embodiment of the device.

FIG. 7 is a perspective view of a cross section of a human head, showing the positioning of the device as embodied in FIG. 6.

FIG. 8 is a flow diagram of the general method of communicating used by some embodiments of the invention.

FIG. 9 illustrates an example network of devices.

FIG. 10 is a perspective view of a cross section of a head, showing a non-limiting position of the device.

FIG. 11 discloses a second position of the device from FIG. 10 inside the oral cavity at a time different than the positioning of the device shown in FIG. 10.

FIG. 12 illustrates various non-limiting shapes of the device.

FIG. 13 illustrates a non-limiting example shape of the device.

FIG. 14 is a flow diagram illustrating certain aspects of a user interface provided by a device for communication between the device and the user.

FIG. 15 illustrates two positions of the same device, according to certain aspects of the disclosure.

FIG. 16 illustrates an embodiment of an example interaction of a user with a user interface provided by a device.

FIGS. 17A and 17B, illustrate a non-limiting example of a user interface provided by the device to the user.

FIG. 18 illustrates a flow diagram for a user interface provided by the device.

### DETAILED DESCRIPTION

Embodiments of the present disclosure are described herein with reference to the drawing figures.

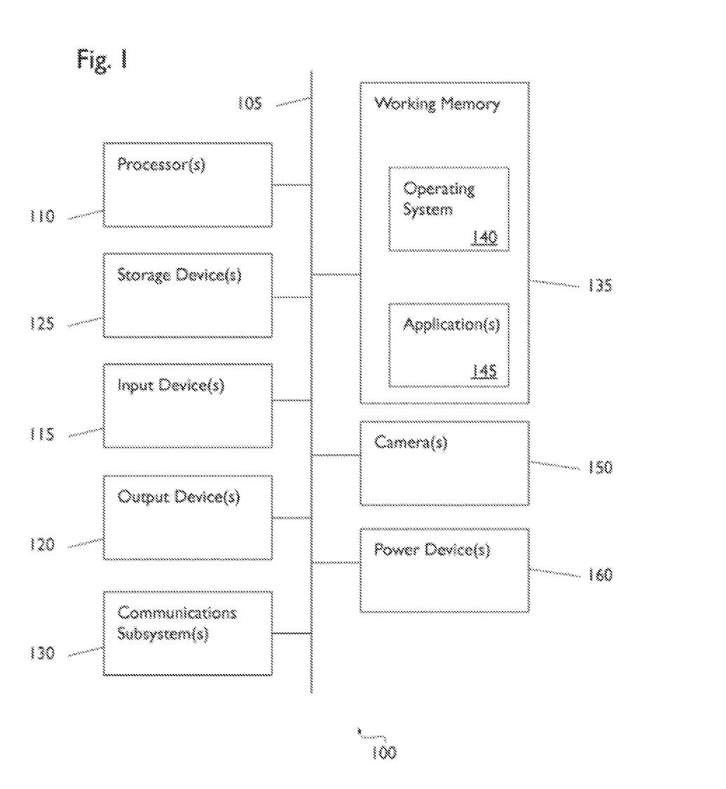

FIG. 1 illustrates an example device incorporating parts of the device employed in practicing embodiments of the invention. An example device as illustrated in FIG. 1 may be incorporated as part of the described computerized device below. For example, device 100 can represent some of the components of a mobile device. A mobile device may be any computing device with an input sensory unit, like a touchpad, and an output unit, like a speaker. Examples of a mobile device include, but are not limited to, video game consoles, tablets, smart phones, camera devices and any other portable devices suitable for performing embodiments of the invention. FIG. 1 provides a schematic illustration of one embodiment of a device 100 that can perform the methods provided by various other embodiments, as described herein. FIG. 1 is meant only to provide a generalized illustration of various components, any or all of which may be utilized as appropriate. FIG. 1, therefore, broadly illustrates how individual system elements may be implemented in a relatively separated or relatively more integrated manner. FIG. 1 is an example portable processing device or mobile device that may use components as described in reference to FIG. 1. In some embodiments, only some of the components described in FIG. 1 are implemented and enabled to perform embodiments of the invention. For example, a touchpad device may have one or more touchpads, storage, or processing components along with other components described in FIG. 1.

The device 100 is shown comprising hardware elements that can be electrically coupled via a bus 105 (or may otherwise be in communication, as appropriate). The hardware elements may include, but are not limited to, one or more power devices 160, including without limitation one or more power storage and/or distribution devices (such as a battery) and/or one or more power generation, storage, and distribution devices (such as a combination of power generator, power management device, and a battery). In other embodiments, power and/or data might be distributed via one or more separate buses, or a combination of buses, and/or individual components of device 100 might have independent or external power device(s) 160. The hardware elements may include, but are not limited to, one or more processors 110, including without limitation one or more general-purpose processors and/or one or more special-purpose processors (such as digital signal processing chips, graphics acceleration processors, random number generator and logic for cryptography, and/or the like). The hardware elements may also include one or more signal-creating input devices 115 which can sense analog input. One or more input devices 115 can include without limitation a touchpad, sensors, sensor devices (example sensor devices discussed in figures and later paragraphs), a microphone, a pushbutton, a gyroscope, and/or an accelerometer and/or the like. For example, a microphone might sense the analog input of sound. The hardware elements may also include one or more output devices 120, which can produce a stimulus to a subject and/or environment and can include without limitation a vibration device, a light device, an electric-shock and/or electrode-array device, devices (example devices discussed in figures and later paragraphs), and/or the like. For example, an electrode-array device might produce a stimulus of an electric shock to a person it might be touching. In addition, hardware elements may also include without limitation one or more cameras 150, as shown in FIG. 1, for acquiring image content.

In other embodiments one or more input devices 115 can include, without limitation: movement tracking sensor devices such as an LED/photo-diode tracking device (as found in an optical mouse) and/or more advanced visual-tracking devices, which can be used to observe and report movement information; pressure sensor devices (like a microphone device, piezoelectric devices, and/or an air pressure sensor device), which can be used to observe and report pressure change information such as sound, vocalizations, breathing or physical stress changes; temperature sensor devices (like a thermometer device), which can be used to observe and report body heat, respiration temperature, external temperature, general temperature, or other temperature information; touch sensor devices (like button devices, switch devices, slider devices, bite pressure devices, piezoelectric devices optical touch devices, rotation sensor devices, optical movement tracking devices and touchpad devices), which can be used to observe and report direct physical interaction and movement information and even indirect physical interaction and movement information; air sensor devices (like machine olfaction devices, gas flow monitor devices, and/or chemical identification devices), which can be used to observe and report breathing, temperature, humidity, pressure, gas flow, gas state, and air quality information; material sensor devices (like machine taste devices, chemical sensor devices, salinity sensor devices, blood analysis devices and/or pH sensor devices), which can be used to observe and report chemical makeup information or other physical characteristics of breath, food, saliva, bodily fluids and/or organs; light sensor devices (like photodiode devices, infrared light sensor devices, light meter devices and/or camera devices), which can be used to observe and report light, distance, thickness, color and movement information; acceleration sensor devices (like an accelerometer or a pedometer device) which can be used to observe and report velocity and/or acceleration change and movement force information; and orientation sensor devices (like a compass device, or a digital gyroscope device), which can be used to observe and report orientation and movement information.

In other embodiments one or more stimulus and/or output devices 120 can include, without limitation: electrical stimulator devices (like electrode devices, electrode-array devices, and/or shock devices), which can be used to communicate to or stimulate the user and/or others by applying electric current via electrodes to the surrounding environment (such as to the surface of the tongue, to the interior of the mouth, or to and/or into the tissue of an embedding site); light devices (like indicator light devices, infrared light devices, or laser light or laser pointer devices), which can be used to communicate to the user or others and/or illuminate by creating visible, infrared and/or ultraviolet light and/or light beams (and projected beams can be used as pointing devices or projector displays by the user); tactile, actuator, or touch-based vibration devices (like vibration motor devices, and Braille terminal devices), which can be used to communicate to the user or others by creating vibration based feedback and tactile or touchable states; physical release devices (like metered chemical release devices (which could release chemicals), spray devices, dispenser devices, or pill dispenser devices), which can be used to release matter to communicate to and/or or stimulate the user and others by releasing or dispensing matter into the surrounding environment; and mechanical wave generator devices (like speaker devices and/or vibration devices and/or bone-conduction transducer devices), which can be used to communicate to the user and others by creating sound and other mechanical waves.

In other embodiments one or more power devices 160 could reside apart from the rest of device 100, including, without limitation, outside any primary enclosure, in a separate enclosure, and/or connected by a tether and/or power transfer device. In other embodiments power may be generated by one or more power devices 160 from, including, without limitation, interaction with the chemicals in the internal and/or external environment (such as electrical interaction as in a battery, by using an exposed anode and cathode), and/or interaction with the chemicals and/or pressure of the bloodstream of the user, and/or interaction with the external environment and/or functioning of organisms and/or one or more devices hosted within the device (such as with a genetically-engineered biofuel device and/or biofuel organism that generates power from oxygen and glucose in the bloodstream of a wearer), and/or interaction with temperature differences in the external environment (such as by coupling a generator with a Stirling engine or other heat engine), and/or by movement (such as by coupling a generator with a self-winding mechanism of the type as used in a self-winding watch and/or capturing the energy of actions performed on device 100), and/or by wireless energy transfer (such as by direct induction, resonant magnetic induction or electromagnetic power reception devices (such as RFID tags)).

The device 100 may further include without limitation (and/or be in communication with) one or more non-transitory storage devices 125, which can comprise, without limitation, local and/or network accessible storage, and/or can include, without limitation, a hard drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including, without limitation, various file systems, database structures, and/or the like.

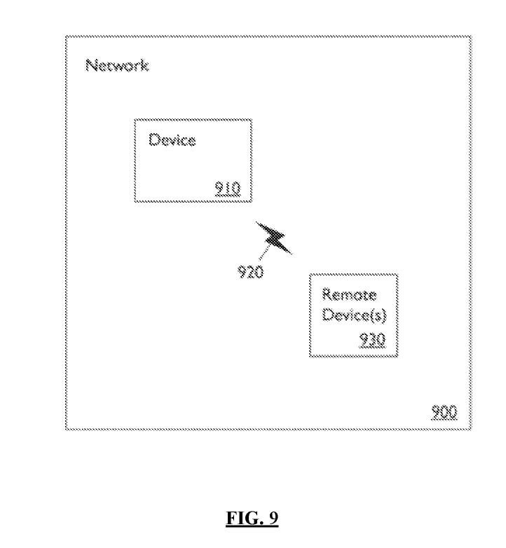

The device 100 might also include without limitation one or more communications subsystems 130, which can include without limitation a network communications device (wireless and/or wired), an infrared communication device, an optical communications device, a wireless communication device and/or chipset (such as a Bluetooth® device, an RFID device (active, passive, or battery-assisted passive), an 802.11 device, a WiFi device, a WiMax device, cellular communication facilities), any kind of signaling circuitry or communications device, including any kind of EMF transmitter/receiver device (which may, without limitation, transmit, receive, both transmit and receive, reflect and/or alter an outside transmission, and the like) a wireless communications device, and/or the like. Bluetooth is a proprietary open wireless technology standard for wirelessly exchanging data, and RFID, Radio-frequency identification, is a wireless non-contact technology that uses radio-frequency electromagnetic fields to transfer data. Communications subsystem 130 could include, without limitation, one or more antenna devices to broadcast and receive electromagnetic signals. Communications subsystem 130 may permit data to be exchanged with an external and/or remote device (such as a mobile device) and/or network, other devices, and/or any other devices described herein. As described herein, the term “external device” and “remote device” may be used interchangeably, without limiting the scope of the disclosure. For example, the external device discussed above may be the same device as the remote device 930 discussed in FIG. 9.

In many embodiments, the device 100 will further comprise a non-transitory working memory 135, which can include a RAM or ROM device, as described above.

Other devices that communications subsystem 130 may permit data to be exchanged with include without limitation other and/or similar embodiments of the invention in and/or on and/or throughout the body of the wearer, and/or in and/or on and/or the body or bodies of one or more other wearers of such devices.

The device 100 also can comprise software elements, shown as being currently located within the working memory 135, including an operating system 140, device drivers, executable libraries, and/or other code, such as one or more programs or application(s) 145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 125 described above. In some cases, the storage medium might be incorporated within a device, such as device 100. In other embodiments, the storage medium might be separate from a device (e.g., a removable medium, such as a compact disc), and/or provided in an installation package, such that the storage medium can be used to program, configure and/or adapt a general purpose computer with the instructions/code stored thereon. These instructions might take the form of executable code, which can be executable by the device 100 and/or might take the form of source and/or installable code, which, upon compilation and/or installation on the device 100 (e.g., using any of a variety of generally available compilers, installation programs, compression/decompression utilities, etc.), then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a device (such as the device 100) to perform methods in accordance with the disclosure. For example, some or all of the procedures of the described methods may be performed by the device 100 in response to processor 110 executing one or more sequences of one or more instructions (which might be incorporated into the operating system 140 and/or other code, such as an application 145) contained in the working memory 135. Such instructions may be read into the working memory 135 from another computer-readable medium, such as one or more of the storage device(s) 125. Merely by way of example, execution of the sequences of instructions contained in the working memory 135 might cause the processor(s) 110 to perform one or more procedures of the methods described herein.

The terms “machine-readable medium” and “computer-readable medium,” as used herein, may refer to any article of manufacture or medium that participates in providing data that causes a machine to operate in a specific fashion. In an embodiment implemented using the device 100, various computer-readable media might be involved in providing instructions/code to processor(s) 110 for execution and/or might be used to store and/or carry such instructions/code (e.g., as signals). In many implementations, a computer-readable medium is a physical and/or tangible storage medium and/or memory storage device. Such a medium may take many forms, including, but not limited to, non-volatile media, volatile media, and transmission media. Non-volatile media may include without limitation optical and/or magnetic and/or solid state drives, such as the storage device(s) 125. Volatile media include, without limitation, dynamic memory, such as the working memory 135. “Computer readable medium,” “storage medium,” and other terms used herein do not refer to transitory propagating signals. Common forms of physical and/or tangible computer-readable media include, for example, a floppy disk, a flexible disk, hard disk, magnetic tape, a solid state memory device, or any other magnetic medium, a CD-ROM, any other optical medium, punchcards, papertape, any other physical medium with patterns of holes, a RAM, a PROM, an EPROM, a FLASH-EPROM, or any other memory chip or cartridge.

Various forms of computer-readable media may be involved in carrying one or more sequences of one or more instructions to the processor(s) 110 for execution. Merely by way of example, the instructions may initially be carried on a magnetic disk and/or a solid state memory device and/or optical disc of a remote computer.

The communications subsystem 130 (and/or components thereof) generally will receive the signals, and the bus 105 then might carry the signals (and/or the data, instructions, etc. carried by the signals) to the working memory 135, from which the processor(s) 110 retrieves and executes the instructions. The instructions received by the working memory 135 may optionally be stored on a non-transitory storage device 125 either before or after execution by the processor(s) 110.

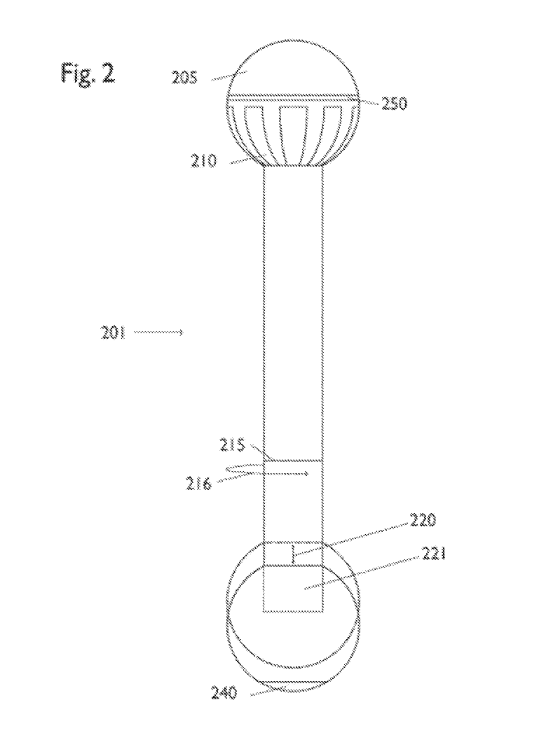

FIG. 2 illustrates an embodiment of the invention as a perspective view of a barbell-shaped jewelry or stud. The stud can include without limitation barbell-shaped enclosure 201, which can be capable of resisting deformation under repeated physical stress. Examples of materials barbell-shaped enclosure 201 could be comprised of include, but are not limited to, metal, plastic, glass, composites, and/or other materials and/or combinations of these materials. In this embodiment, barbell-shaped enclosure 201 may be the shape of a cylinder joining larger-diameter spherical shapes at either end along the long center axis, and may be of appropriate size to pierce through a lip and/or tongue of a mouth, and/or other size. In alternate embodiments, barbell-shaped enclosure 201 might have different shapes and/or sizes, including without limitation disk-shaped and/or asymmetrically-shaped ends instead of spherical ends, a larger and/or smaller size, an asymmetrical shape, a longer or shorter cylinder and/or other shapes and/or sizes. In other embodiments, barbell-shaped enclosure 201 might be shaped to grip or contact surfaces of the mouth in other ways, such as one or more oblong end shapes instead of spherical ends to allow easier rotation of the ends and/or the device, and/or one or more stylus point ends for writing and/or doing finer movements. This embodiment may be implemented using one or more components as described in FIG. 1 and/or in previous paragraphs. In this embodiment of the invention, touch sensor device 205, a pressure sensor device 250, signal light 240, and an electrical stimulator device 210 fit into the surface of barbell-shaped enclosure 201. In this embodiment of the invention, a rotation sensor device 215 bisects the cylinder, allowing for a twisting and/or rotating 216 of the ends of the device along the long center axis and compression sensor device 221, which allows the housing a compression (and/or expansion) 220 (the motion might also be used to generate power for power device 160), fits into the surface of barbell-shaped enclosure 201. In other embodiments of the invention, these devices might be differently-located, omitted, and/or duplicated at multiple locations, such as having an instance of touch sensor device 205 at both ends of the device, having rotation sensor device 215 closer to one of the ends of the cylinder section of barbell-shaped enclosure 201, or other differences.

In this embodiment of the invention, processor 110 can be a small Arduino-compatible microcontroller, and communications subsystem 130 can be a Bluetooth radio device with antenna.

In this embodiment of the invention, working memory 135 can be a flash-memory integrated circuit.

In this embodiment of the invention, multiple one or more input devices 115 can be: touch sensor device 205, a touchpad sensor; rotation sensor device 215, a rotation sensor; compression sensor device 221, a compression-sensing sensor; pressure sensor device 250, a microphone sensor; and two internal accelerometer and/or gyroscope sensor devices (one in each end of the device).

In this embodiment of the invention, power device 160 can be a battery.

In this embodiment of the invention, one or more output devices 120 are: electrical stimulator device 210, an electrical stimulator with two or more electrodes; signal light 240, an LED light; and two internal mechanical wave generator devices (one in each end of the device), vibration-producing devices.

In this embodiment of the invention, storage device 125 can be a flash-memory integrated circuit.

In this embodiment of the invention, operating system 140 can be machine code that can be read by processor 110 and can guide the functioning of device 100.

In this embodiment of the invention, application 145 can be code that can be read by processor 110 and can guide additional functioning of device 100.

Using communications subsystem 130, the embodiment of the invention illustrated in FIG. 2 might be in communication with remote devices and/or similar devices, including, but not limited to other devices in and/or on and/or near the body of the wearer (such as a head-mounted display device, a wrist-mounted display device, a pacemaker device, an insulin pump device, a mobile device, a network device, a wireless device, and/or a home automation device), and/or remote devices, and/or networks of devices, and/or devices. Merely by way of example, device 100 might allow the wearer, by interacting with one or more input devices 115, to communicate to a remote device such as a head-mounted visual display device to control a cursor or change a selection presented in the visual display device.

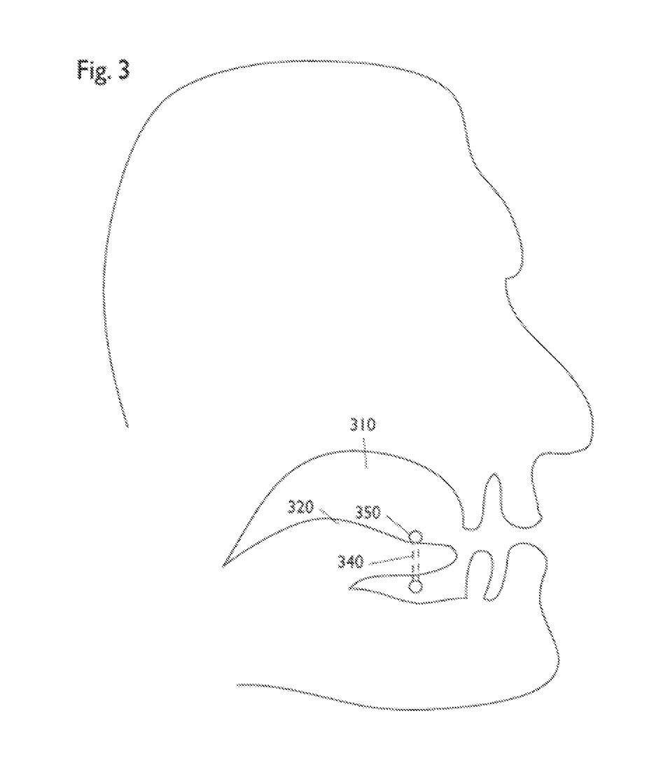

FIG. 3 is a perspective view of a cross section of a head (in this case a human head), showing one possible position of device 350 (the device described in FIG. 2 and preceding paragraphs).

In FIG. 3, device 350 can be anchored through and/or in one or more pierced site(s) 340 around and/or in an oral cavity 310 of the wearer, through and/or in a tongue 320. In this embodiment the wearer is a human, but in other embodiments and/or usages, the wearer might be any kind of animal. In other embodiments and/or usages, positioning of device 350 might be in and/or through one or more pierced sites 340 in and/or through one or more other locations and/or one or more orientations around and/or in and/or through and/or under the tissue surrounding and/or near oral cavity 310 (such as through a lip), and/or anywhere around and/or in and/or through and/or within the body and/or form of a user. Tongue 320 (and/or other tissues of the mouth and/or body) could have one or more pierced sites 340 and/or one or more one or more devices 350 and/or other embodiments of the invention.

Oral cavity 310 and/or tongue 320 could also have multiple one or more pierced sites 340 and/or multiple one or more devices 350 and/or other devices.

Using communications subsystem 130, device 350 might be in communication with remote devices and/or similar devices, including, but not limited to other devices in and/or on and/or near the body of the wearer (such as a head-mounted display device, a wrist-mounted display device, a pacemaker device, an insulin pump device, a mobile device, a network device, a wireless device, and/or a home automation device), and/or remote devices, and/or networks of devices, and/or devices. Merely by way of example, device 350 might allow the wearer, by interacting with one or more input devices 115, to control a cursor or change a selection presented in the visual display of a separate head-mounted display device and/or provide feedback to the environment of oral cavity 310 about the remote action in the remote device in the form of a vibratory or haptic vibration within device 350.

In one embodiment, the barbell-shape of barbell-shaped enclosure 201 may be advantageous since it houses and protects the device and resists deformation under physical stress and keeps the device in pierced site 340.

In this embodiment of the invention, from pierced site 340, the input devices 115 of device 350 might observe tongue 320, the tissues of the mouth, and/or the environment of oral cavity 310 (and/or beyond): touch sensor device 205, a touchpad sensor device, can sense touch (as device 350 moves with tongue 320 and comes in contact with mouth tissues (such as the gums, teeth, lips, floor of the mouth, upper palate, and the like) and/or other objects and/or devices); rotation sensor device 215, a rotation sensor device, can sense rotation of the ends the device (this could be accomplished using the tongue or other tissues of the mouth, or by the fingers, reaching into or up to the mouth, and could, merely by way of example, be used as an on/off switch for the device); compression sensor device 221, a compression-sensing sensor device, can sense compression (and/or expansion) 220 (and compression sensor device 221 can be returned to its resting state by a spring, or the like) of the cylinder of device 350 (such as by flattening and/or fattening of tongue 320, and/or by pressing or pulling on the ends of device 350 in other ways); pressure sensor device 250, a microphone sensor device, can sense sound, such as vocalizations and/or sub-vocalizations, breathing, and other sounds that come into oral cavity 310; and two internal accelerometer and/or gyroscope sensor devices (one in each end of the device), orientation and/or acceleration sensor devices, can sense the orientation and/or acceleration of device 350 (which can be affected by actions of pierced site 340, and/or tongue 320).

In this embodiment of the invention, tongue 320, the tissues of the mouth, and/or the environment of oral cavity 310 (and/or beyond) might also observe device 350, including output devices 120 of device 350: electrical stimulator device 210 can create sensation via electric current; signal light 240 can create light and light beams; and the two internal mechanical wave generator devices (one in each end of the device), can create vibration and/or vibration differentials and/or one or more stereo vibration fields and/or haptic fields and/or patterns.

In this embodiment of the invention, the dexterity, and/or communication abilities of the mouth can now be used for, among other things, fine control, interaction, and exchange of information to and/or from and/or through device 350.

Using one or more input devices 115, some embodiments of the invention might observe and act on analog input from the environment of the mouth and/or entering the environment of the mouth, such as a material sensor device being used to monitor and/or analyze and/or report blood chemical levels, gas levels in the breath, and/or chemical makeup of food ingested of and/or by the user.

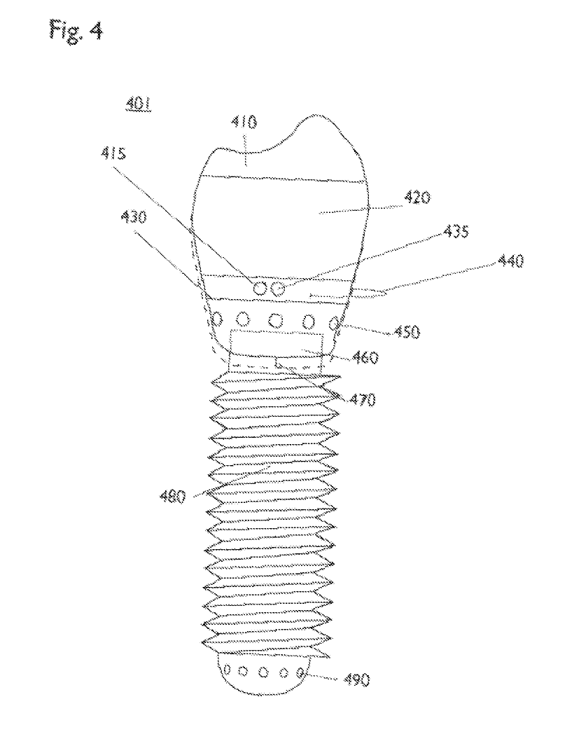

FIG. 4 is a perspective view of a tooth-implant shaped enclosure, according to another embodiment of the present invention. Tooth implant shaped enclosure 401 may be implemented using one or more components as described in FIG. 1 and/or in previous paragraphs.

In this embodiment, tooth implant shaped enclosure 401 has a tooth-shaped enclosure 410 of ceramic or other material that houses and protects the device. Tooth-shaped enclosure 410 can look similar to a tooth or teeth. In other embodiments, tooth-shaped enclosure 410 might mimic, partially mimic, and/or not mimic other structures, and/or have a different shape and/or shapes.

Tooth-shaped enclosure 410 may house touch sensor device 420 (a touch-sensing device, such as a touchpad, which can wrap around tooth shaped enclosure 410), rotation sensor device 430 (that can sense twisting or rotating 440), compression sensor device 460 (that can sense compression (and expansion) 470), electrical stimulator device 450, and may have tooth implant anchor 480, which may also have anchor electrical stimulator device 490. In other embodiments, tooth implant shaped enclosure 401 might lack tooth implant anchor 480, and, instead connect to an external tooth implant via an implant connection socket.

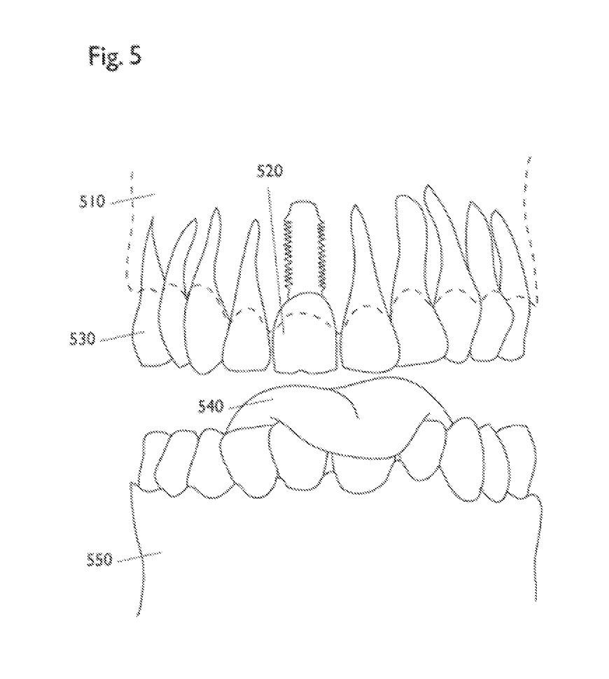

FIG. 5 is a perspective view inside a mouth, with teeth (including tooth 530), upper gums/maxilla 510, lower gums/mandible 550 and tongue 540, with upper gums/maxilla 510 hidden to show the full teeth. FIG. 5 shows the device, as embodied in FIG. 4, worn in one possible tooth implant location 520 in the upper gums/maxilla 510. This embodiment may be implemented using one or more components as described in FIG. 1 and/or in previous paragraphs.

In this embodiment of the device, one or more input devices 115 may include without limitation: one or more touch sensor devices 420 (built into the surface of the housing) that responds to touch input and/or can create ‘mouse’-type positioning, tap, pressure, coverage and/or touch-related data; compression sensor device 460 inside the housing that responds to compression (and expansion) 470 along the length of the housing; a rotation sensor device 430 in the housing that can sense twisting or rotating 440 the two ends of the device; a pressure sensor device 435 that responds to air pressure; and one or more internal accelerometer and/or gyroscope sensor devices, orientation and/or acceleration sensor devices that can sense the orientation and/or acceleration of tooth implant shaped enclosure 401.

In this embodiment of the device, one or more output devices 120 may include without limitation: a mechanical wave generator device that can be a vibration device and/or or a speaker device (a vibration device creates vibration in the device using a vibration motor device or other vibration-causing device, a speaker device creates sound waves from the device by creating movement using a speaker or other movement-creating device); signal light 415, a light device (a light device can display one or more lights and/or beams of light) that displays a light; an electrical stimulator device 450 that can create sensation in the wearer via electric shocks from electrodes, and/or anchor electrical stimulator device 490, that can create sensation in the wearer via electric shocks from electrodes. The actions of the output devices 120 can be perceived by the user and/or others.

FIG. 5 is a perspective view of the teeth, gums and tongue of a human mouth, showing the position of the device as embodied in FIG. 4. This embodiment may be implemented using one or more components as described in FIG. 1 and/or in previous paragraphs. In this embodiment of the invention, the device can be worn in a user's mouth, such as in FIG. 5, embedded in upper gums/maxilla 501, or lower gums/mandible 550 by the titanium (or other, suitable material) threads of tooth implant anchor 480. In this placement of the device, one or more input devices 115 (such as touch sensor device 420, compression sensor device 460, rotation sensor device 430, pressure sensor device 435, and the internal accelerometer and/or gyroscope sensor device) can be manipulated by the tongue 540, lips, other parts of the mouth and/or by other means (such as movement of the head or jaw).

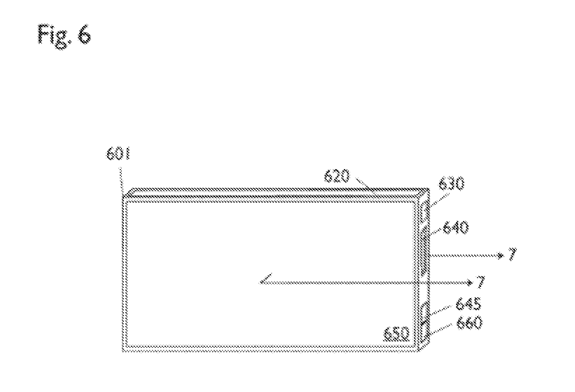

FIG. 6 is a perspective view of a dental bridge-shaped enclosure, according to an embodiment of the present invention. This embodiment may be implemented using one or more components as described in FIG. 1 and/or in previous paragraphs. The dental bridge-shaped enclosure includes without limitation bridge enclosure 601 of metal, pyrex, plastic, or other material or materials that houses and protects the device. Bridge enclosure 601 can be affixed to the teeth of the mandible via regular bridge attachment methods or as part of a dental retainer, such as a Hawley retainer.

Bridge enclosure 601 can allow one or more input devices 115 to observe the environment around the device and one or more output devices 120 to act (directly or indirectly) on the environment around bridge enclosure 601, while sealing and protecting device 100 from damage.

In this embodiment of the invention, one or more input devices 115 may include: a touch sensor device 650 (built into the surface of the housing) that can respond to touch input and/or can create ‘mouse’-type positioning, tap, pressure, coverage and/or touch-related data; a compression sensor device 620 inside the housing; a compression switch 630; a pressure sensor device 660 that can respond to air pressure, and a internal accelerometer and/or gyroscope sensor device, orientation and/or acceleration sensor devices that can sense the orientation and/or acceleration of bridge enclosure 601.

In this embodiment of the invention, one or more output devices 120 may include, but are not limited to: a mechanical wave generator device that can create vibrations from a vibration motor device; a light device that can display a signal light 640; and a shock device that creates small electric shocks from an electrodes of electrical stimulator device 645, arrayed on the surface of the device.

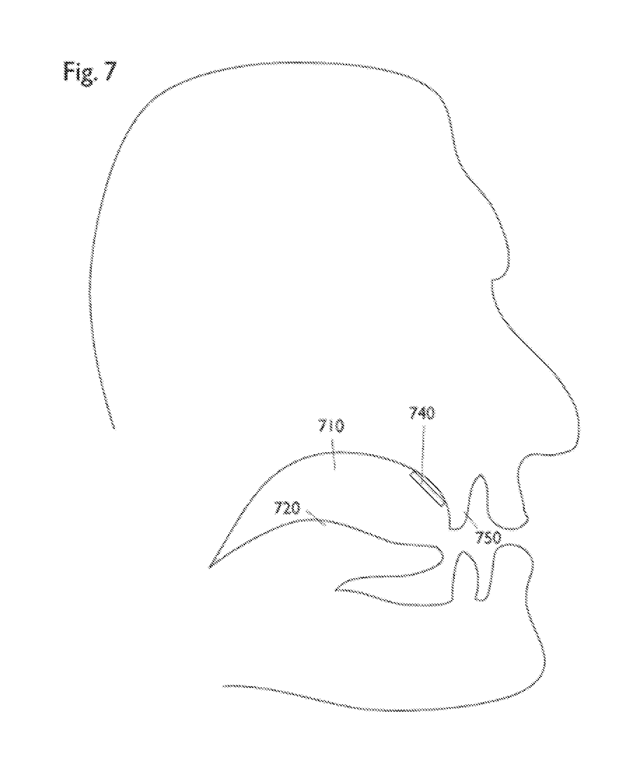

FIG. 7 is a perspective view of a cross section of a human head, cut away to show the oral cavity 710, the tongue 720, and the device 740, as embodied in FIG. 6, worn in one possible location, affixed to the teeth of mandible 750 in the orientation as indicated by lines 7-7 in FIG. 6. This embodiment may be implemented using one or more components as described in FIG. 1 and/or in previous paragraphs.

In this embodiment, the device can be worn in a user's mouth, such as in FIG. 7, affixed to the teeth of the mandible 750. In this placement of the device, tongue 720 can access touch sensor device 650, and compression sensor device 620 can be manipulated by the tongue 720, lips, other parts of the mouth and/or by other means. And the actions of one or more output devices 120 can be perceived by the user and/or others. In regular operation of the device, tongue 720 can stay in a fairly relaxed position along the mandible and can stay clear of blocking most regular mouth function.

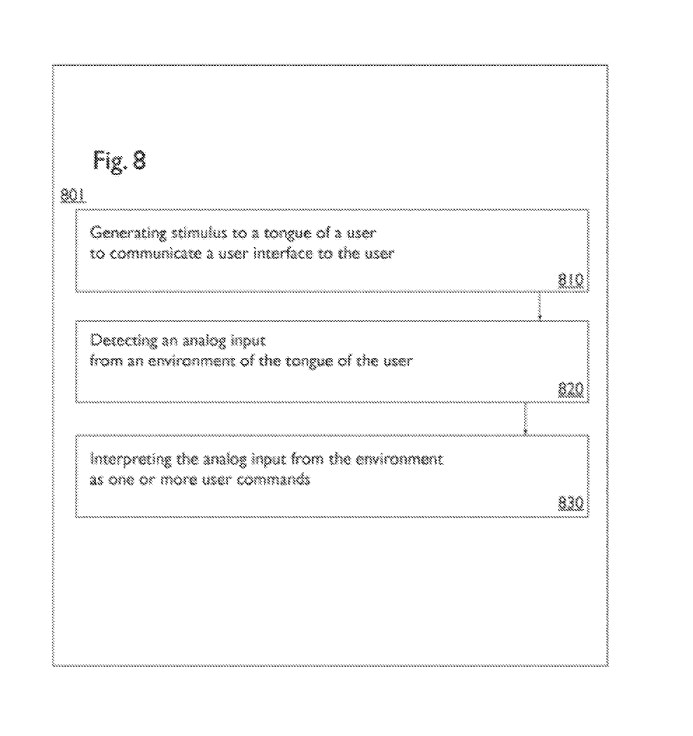

FIG. 8 is a flow diagram of the general method for communicating 801 used by the some embodiments of the invention, comprised of three steps: step one—generating stimulus to a tongue of a user to communicate a user interface to the user 810; step two—detecting analog input from an environment of the tongue of the user 820; and step three—interpreting the analog input from the environment as one or more user commands 830.

In step one, generating a stimulus to a tongue of a user to communicate a user interface to the user 810, some of the user interface, the system by which the user interacts with the device, is communicated to the user via one or more output devices 120. For example, without limitation, one or more points of stimulus (perhaps each with a distinct pattern or signature of stimulation) might be generated by electrical stimulator device 210 to the tongue of the user, representing information and/or distinct options and/or choices of operating system 140 and/or one or more applications 145 to be perceived by the user. In other embodiments, without limitation, the stimulus of step one might involve one or more various patterns, sequences, loops, haptic signatures, intensities, orientations, locations, apparent locations, stereo locations, verbosities, speeds, scales, tones, and the like and/or can be used to communicate information to the user, including, but not limited to, information about the state of one or more processors 110, working memory 135, operating system 140, one or more applications 145, external devices, and the like.

In step two, detecting analog input from an environment of the tongue of the user 820, analog input, states and/or activity in the mouth environment can be received and/or detected by one or more input devices 115 and/or can be stored in working memory 135 and/or storage device 125 and/or device 100.

In step three, interpreting the analog input from the environment as one or more user commands 830, the analog input detected and/or stored in step two can be interpreted by one or more processors 110 and/or operating system and/or one or more applications 145 as one or more user commands, instructions that can be converted by device 100 to the appropriate operating system 140 function and/or functions. For example, without limitation, fattening and/or flattening of the user's tongue, detected by compression sensor device 221, might be interpreted as a user command to select, and/or cycle through choices or options of operating system 140, and/or one or more applications 145.

In some embodiments of the invention, the wearer of the device can use the device to communicate to one or more external devices, including, but not limited to, communicating commands and data with other devices, and communicating input and/or about input detected by one or more input devices 115. Merely by way of example, device 100 could be used to analyze accelerometer and/or gyroscopic and/or audio data about vocalizations (or sub-vocalizations) and tongue position to compare or predict text of speech.

FIG. 9 illustrates a schematic drawing of an example computer network infrastructure. Device 910 may be implemented using one or more components as described in FIG. 1, and/or other figures, and/or in previous paragraphs. In network 900, device 910 communicates using a communication link 920 (e.g., a wired or wireless connection, implemented by communications subsystem 130) with one or more external or remote devices 930 (which can be, without limitation, in various proximity to device 910, for example in the same mouth, or across a distance of miles to a communications tower). Communication link 920 may be one way (in either direction) or two way (for example, device 910 could receive a transmission from, transmit to, or receive from and transmit to one or more remote devices 930). Remote device 930 may be any type of device that can receive and/or transmit data. Device 910 can act as a hub or spoke of the network. Remote device 930 might act as a hub or spoke of the network. One more remote devices 930 might have communication 920 with device 910, and/or other communication between remote devices 930. Network communication is therefore possible. Merely by way of example, device 100 could be used to send data detected by touch sensor device 650 as mouse-type data to one or more remote devices 930, such a laptop computer, in order to control its mouse and/or cursor. Merely by way of example, device 100 could be used to receive and compare data detected by pressure sensor device 250 with data communicated 920 from one or more remote devices 930, such a laptop computer with a microphone and a wireless card, in order to compare and/or clarify vocalized sounds.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

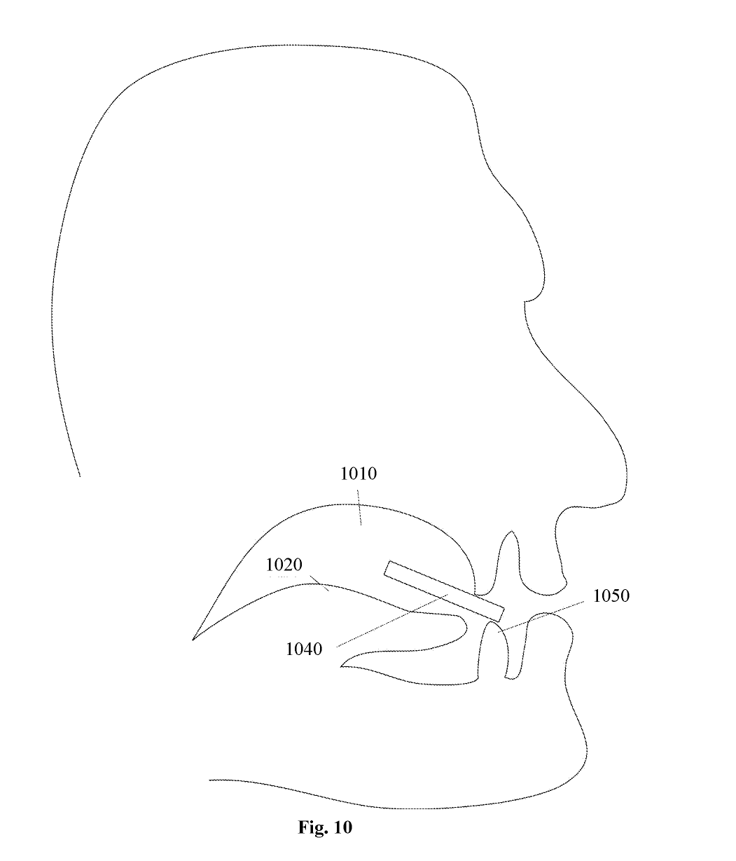

FIG. 10 is a perspective view of a cross section of a head (in this case a human head), showing one possible position of device 1040. Several components of the device 1040 are described in more details in FIG. 1 and FIG. 2.

In FIG. 10, device 1040 is configurable to operate in the human (or another animal with oral cavity) oral cavity. The shown embodiment illustrates a human head, but in other embodiments and/or usages, the user of the device 1040 might be any kind of animal. For example, FIG. 10 illustrates the position of the device 1040 temporarily held by the teeth 1050 of the upper and lower jaw. FIG. 10 discloses an illustrative position and is in no way limiting. At least in one implementation, the device 1040 shown in FIG. 10 is not affixed to any portion of the oral cavity and is easily maneuverable by the human. For example, the human may move the device 1040 inside the oral cavity using teeth 1050 and tongue 1020. In other words, the device 1040 is free floating inside the oral cavity and maneuverable by the human using portions of the oral cavity.

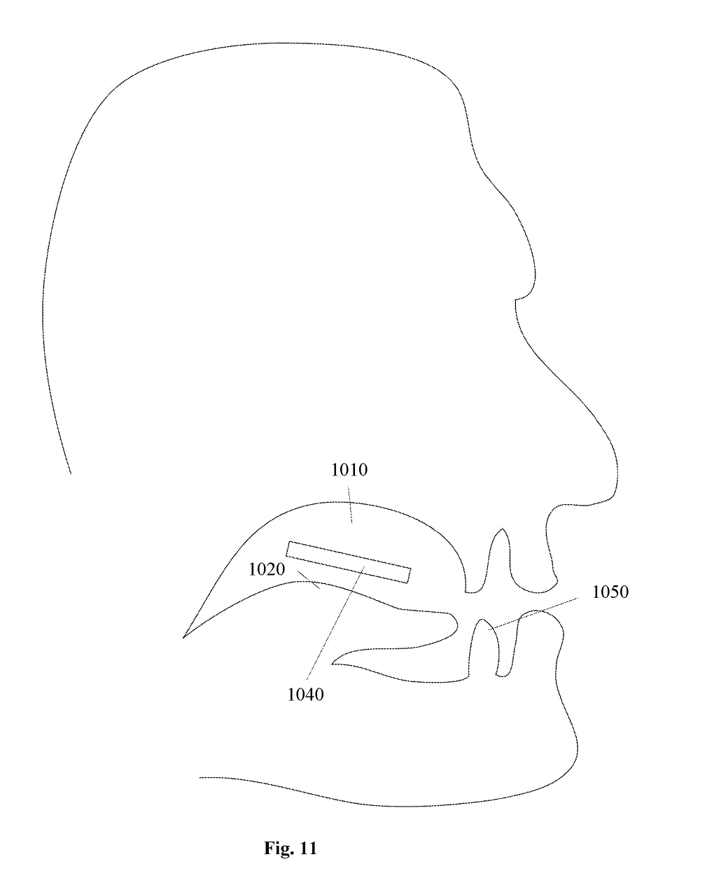

FIG. 11 discloses a second position of the same device 1040 inside the oral cavity at a time different than the positioning of the device 1040 shown in FIG. 10. Therefore, the human can move the device from the first position shown in FIG. 10 to a second position shown in FIG. 11 using their teeth and/or tongue to maneuver the device 1040.

Ability to easily maneuver the device 1040 may be advantageous in freely placing the device 1040 in the oral cavity while in use or in anticipation of use and taking it out while the device 1040 is not in use. Furthermore, changing the position of the device 1040 may indicate a command or a change in the mode of operation of the device. Moreover, the device's 1040 friction against portions of the oral cavity, such as the tongue can also provide for commands or convey information to the user and/or the device and hence may provide a communication channel between the device 1040 and the user.

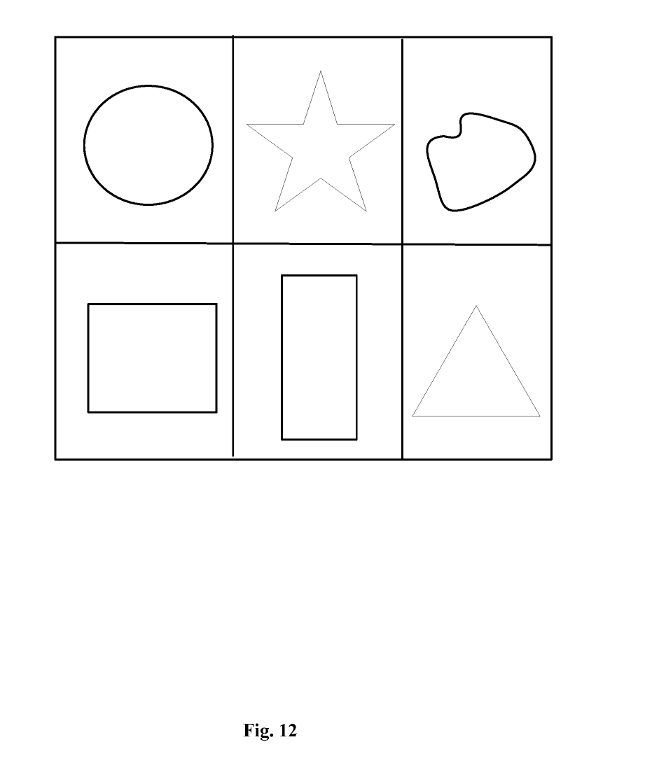

FIG. 12 illustrates various non-limiting shapes of the device 1040. For example, the device 1040 can be disc shaped, star shaped, irregularly shaped, square shaped, rectangular shaped, or triangularly shaped. The shapes shown in FIG. 12 are mere examples of the different shapes of the free floating device 1040 placed in the oral cavity. The shape of the device 1040 may be determined based one or more factors, such as size, maneuverability, size of the electronic components encased by the device 1040, size of the sensors, the user interface needed for communicating information between the user and the device 1040, or any combination thereof. Both, the size of the device and the size of the oral cavity may both be considered in determining the shape of the device 1040. For example, the size of the oral cavity of a human may be different from the size of a dog.

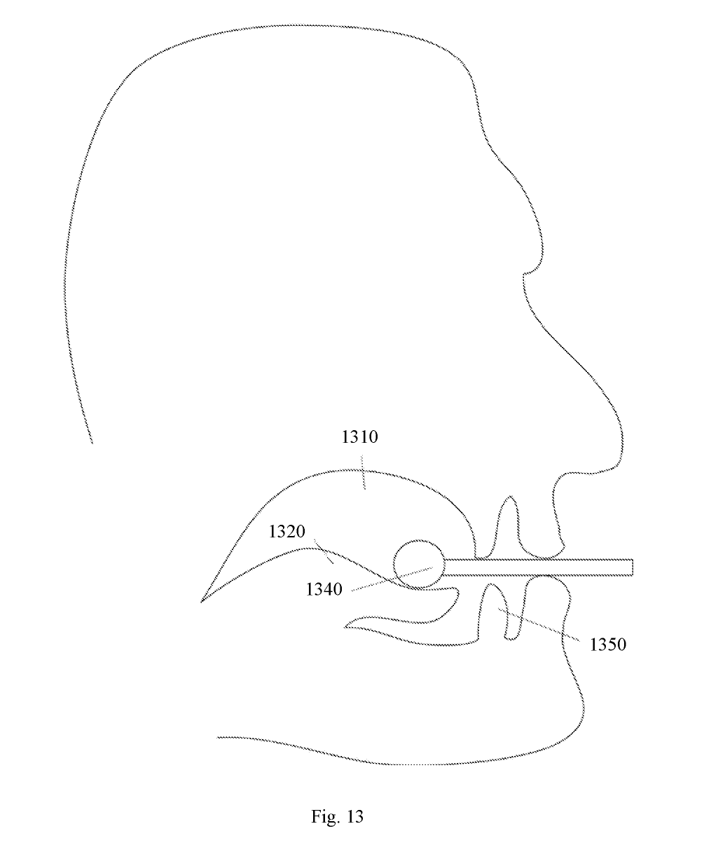

FIG. 13 illustrates a lollipop shaped device 1340. Several components of the device 1340 are described in more details in FIG. 1 and FIG. 2. The lollipop shape illustrated in FIG. 13 has a spherical ball connected to an elongated cylinder, tube, pole, or stick. FIG. 13 is for illustration purposes and in non-limiting. For example, in certain embodiments an irregular or a different shape may be used instead of a spherical ball. Furthermore, the elongated cylinder may also have irregularities in shape to facilitate components and/or to accommodate maneuverability.

FIG. 13 illustrates that the spherical ball of the device 1340 is inside the oral cavity 1310. The user may use portions of the oral cavity 1310, such as the tongue 1320 to communicate with the device 1340, as illustrated in other sections of this disclosure. For example, the user may communicate with the device 1340 using a button, friction, vibrations, electric stimulus, etc. or any combination thereof.

In some instances, the shape of the device 1340 enables the user to grip and maneuver the device 1340 using their upper and lower teeth 1350 and other portions of the oral cavity 1310. Furthermore, the elongated cylinder or stick may enable the user to handle or maneuver the device like a lollipop with their hands, avoiding direct hand contact with saliva. This may be advantageous for hygienic reasons, where direct and repeated contact with saliva may spread germs from and to the user of device 1340.

The lollipop shaped device 1340 may be handled using the elongated cylinder or stick and placed in such a way when not in use that the spherical ball is encased in a case, such as a plastic case. Furthermore, in some embodiments, the cylindrical stick may be coupled to a lanyard. This may be helpful for always keeping the device 1340 easily accessible. This may also enable the user to just drop or spit the device 1340 from the oral cavity knowing that the device 1340 is connected to the lanyard and will not get displaced or fall on the ground. This may be useful for individuals with disabilities where handling and safe keeping a device might be challenging.

The lollipop shaped device 1340 may also enable placement of components in a novel configuration. For example, in certain embodiments, the antennae for receiving and transmitting information to a remote device may be placed in the elongated cylinder. This may allow for better reception at the antenna and also avoid direct exposure of the head to radiations transmitted to the device 1340.

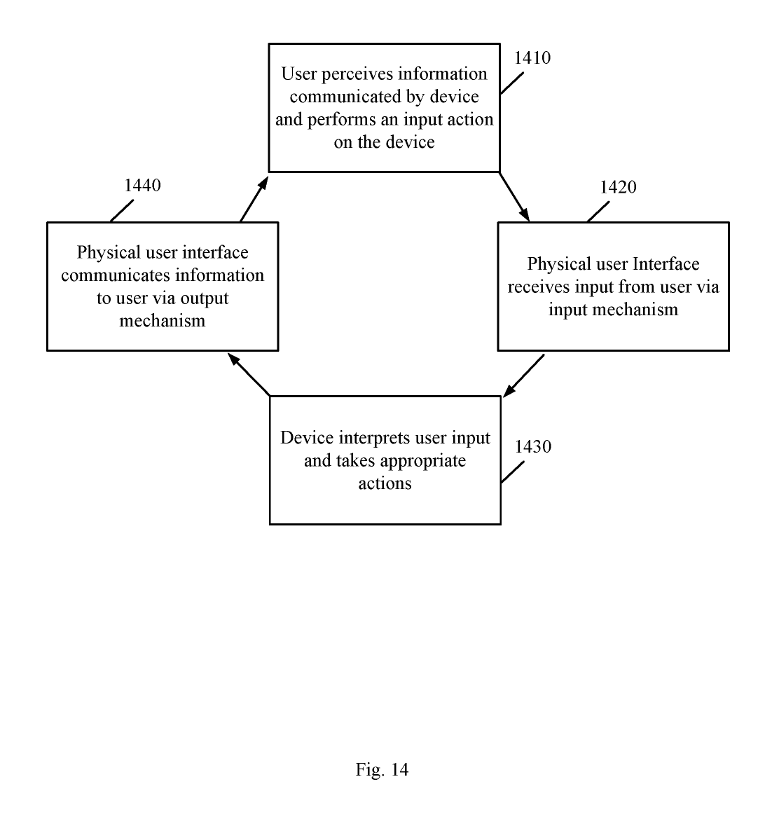

FIG. 14 is a flow diagram illustrating certain aspects of a user interface provided by a device for communication between the device and the user. Certain aspects of the steps described with respect to FIG. 14 may be performed in hardware, software, firmware or any combination thereof. For example, instructions executed by processing logic and stored on a non-transitory computer readable medium may be used for performing certain steps discussed with respect to FIG. 14.

Blocks 1410, 1420, 1430 and 1440 illustrate a communication channel between the user and the device. The device provides a physical user interface to the user for the user to communicate with the device.

At block 1410, user perceives information communicated by device and performs an input action on the device.

At block 1420, the physical user interface of the device receives input from user via input mechanism. The input from the user may be tactile (e.g., touch), orientation of the device itself (e.g., orientation of free floating device 1040), sound (e.g., user voice) or switching and clicking of a logical or physical button that responds to pressure from the user.

At block 1430, device interprets user input received through the physical user interface and takes appropriate actions. In certain embodiments, a pre-negotiated logical user interface, such as Morse code may be used in interpreting user input. For example, the user may tap the device in a particular manner to provide a Morse code to the device. In other instances, the user may train the device to interpret certain input as specific commands. In yet other implementations, the device may be pre-configured to identify certain commands or may have a self-learning features where the device may adaptively change its setting based on certain pre-programmed criteria. For example, change in the orientation of the device may switch the device from one mode of operation to another.

At block 1440, physical user interface communicates information to user via output mechanism. The device itself may communicate information to the user using a myriad of different techniques. In certain embodiments, the device may project information to the user using multiple dimensions (e.g., stereo vs. linearly). For example, multiple vibration motors may be used in generating stereographic vibrations in the oral cavity in multiple dimensions. The user may be able to detect the region of the oral cavity that the vibration is most strongly associated with and accordingly attribute a meaning to that vibration. For example, the device may be able to communicate information about a passing of an object in front of the user, by associating the vibrations with the object passing by. This may help a visually impaired individual gauge motion of objects in its vicinity. Similarly, a gaming system may provide additional tactile information to a user through a device in their oral cavity regarding the video game.

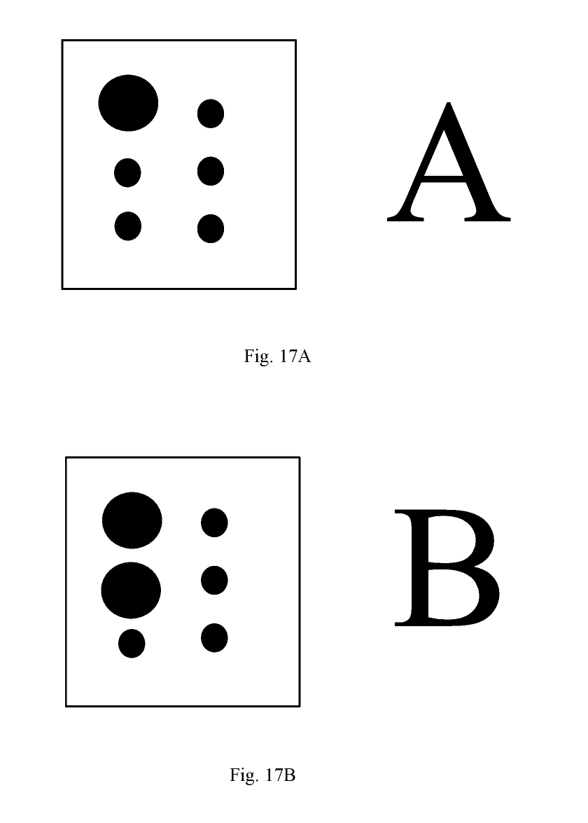

In addition to or alternatively to vibrations, the device may provide electrical pulses or physical deformations to convey information to the user. Such physical deformations and/or electrical pulses are discussed in more detail with reference to FIG. 17A and FIG. 17B.

The above described steps may occur in any order. For instance, the user may initiate the flow cycle by providing input to the device or the device may initiate the flow cycle by providing information to the user. Therefore, the above steps may be performed in any order without deviating from the scope of the disclosure.

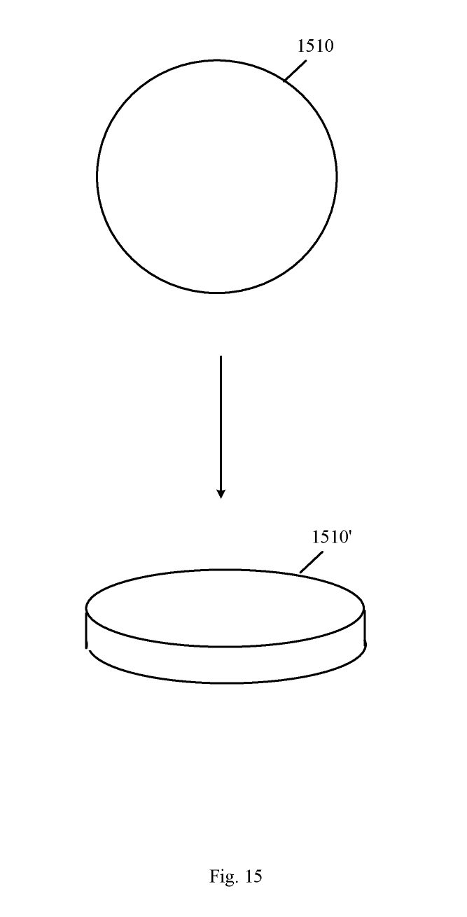

FIG. 15 illustrates two positions of the same device, according to certain aspects of the disclosure. Device 1510 is similar to the free floating device 1040 discussed with respect to FIG. 10. Device 1510 and device 1510′ are the same devices at different points in time. For instance device 1510 illustrates the device in a first position at a first time and device 1510′ illustrates the same device in a second position at a second time. Specifically, device 1510 is a top down view of a cylindrical disc. FIG. 15 shows only the top portion of the cylindrical device 1510. Moreover device 1510′ shows the device in a different position, and illustrates a side view of the cylindrical disc. It should be noted, that FIG. 15 is only for illustration purposes and the interpretation of the orientation of the device to a command or user input may be configurable by the manufacturer, vendor, user or the device itself.

The orientation of the device 1510 may be manipulated by the user of the device to indicate a command to the device 1510 itself. For example, changing the orientation of device 1510 as illustrated in FIG. 15 may indicate to the device that the user is ready to provide instructions or that the device should switch to particular mode.

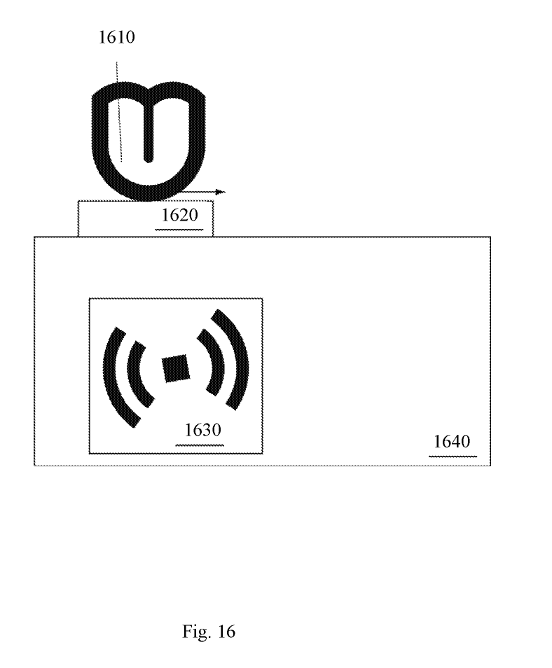

FIG. 16 illustrates an embodiment of an example interaction of a user with a user interface provided by a device. FIG. 16 may be a non-limiting example of the flow diagram of FIG. 14 illustrating certain aspects of a user interface provided by a device for communication between the device and the user.

As discussed with reference to block 1410, the user may use its tongue 1610 to provide input to the device by moving its tongue 1610 across a sensor 1620. As discussed with reference to block 1420, the user interface, such as the sensor 1620 may use friction, touch, optical waves, heat signatures, cameras or any other suitable technology to receive input, i.e., detect the movement of the tongue 1610 across the sensor 1620. The user interface provided by the sensor 1620, may be referred to a physical user interface for receiving physical input from the user. Although, the sensor 1620 is shown as protruding from the device in FIG. 16, the sensor in some implementations it may be flush with the surface of the device 1640.

As discussed with reference to 1430, the device 1620 may use a logical user interface to process the physical user interface and determine the action associated with the physical input. For example, in FIG. 16, the device may interpret the movement of the tongue 1620 across the sensor as an instruction to move the cursor for a remote device across the screen and process such a request.

As discussed with reference to block 1440, the device 1640 may communicate information to the user via the output mechanism. In FIG. 16, a non-limiting example of an output mechanism is shown as a vibration module 1630. In one simple example, the device 1640 may provide feedback for the movement of the tongue 1610 across the sensor 1620 by providing vibration feedback using the vibration module 1630. The vibrations may be provided back to the tongue 1610 or other portions of the oral cavity. The vibration module 1630 is an example of an output mechanism. Other output mechanisms may include actuators, sound, and other output mechanisms discussed throughout this disclosure.

FIGS. 17A and 17B, illustrate a non-limiting example of a user interface provided by the device to the user. The user interface may have a physical user interface and a logical user interface. As shown in FIGS. 17A and 17B, the device may be configured to provide a physical user interface to the user by temporally deforming or providing low-voltage electrical pulses to the user. The surface of the device may be temporarily deformed by using physical actuators, passing heat and/or electrical charges through portions of the surface to cause temporary deformations, pumping liquid through certain portions under the surface to cause temporary deformations or any other suitable techniques. The surface of the device may provide a low-voltage electrical pulse to the user in the form of a mild shock or sensation to the user or any other suitable technique.

The physical user interface may be complemented with a logical user interface that allows the user and the device to communicate using a standardized interface. For example, the physical user interface, such as the temporary deformations of the physical surface of the device or the low-voltage electrical pulses may communicate the structure or pattern to the user. However, a logical user interface is needed to interpret the physical input provided to the user. For example, dots communicated to the user through physical deformations of the surface may be interpreted by the user as the letter “A” or letter “B”, as shown in FIG. 17A and FIG. 17B, respectively, based on the interpretation of the dots according to Braille language. In the alternative, the temporal deformations or electrical pulses may be paced in time to provide a code. This code can be interpreted as letters “A” and “B” as well using a Morse code interpretation (i.e., logical user interface).

In the above examples, the physical deformations or the electrical pulses are the physical user interface, whereas the Braille language or the Morse Code represents the logical user interface.

As such, the physical user interface is the physical stimuli generated by the device as the user interface so that the user can interpret the physical stimuli. In some instances, the user may also respond to the physical stimuli. The logical user interface is the convention or standard pre-determined between the user and the device that provides meaning to the physical stimuli generated by the device. For example, the physical deformation of the surface of the device provides the physical user interface, whereas the Braille language is the pre-determined convention that is generated by the deformations and used for interpreting the deformations by the user.

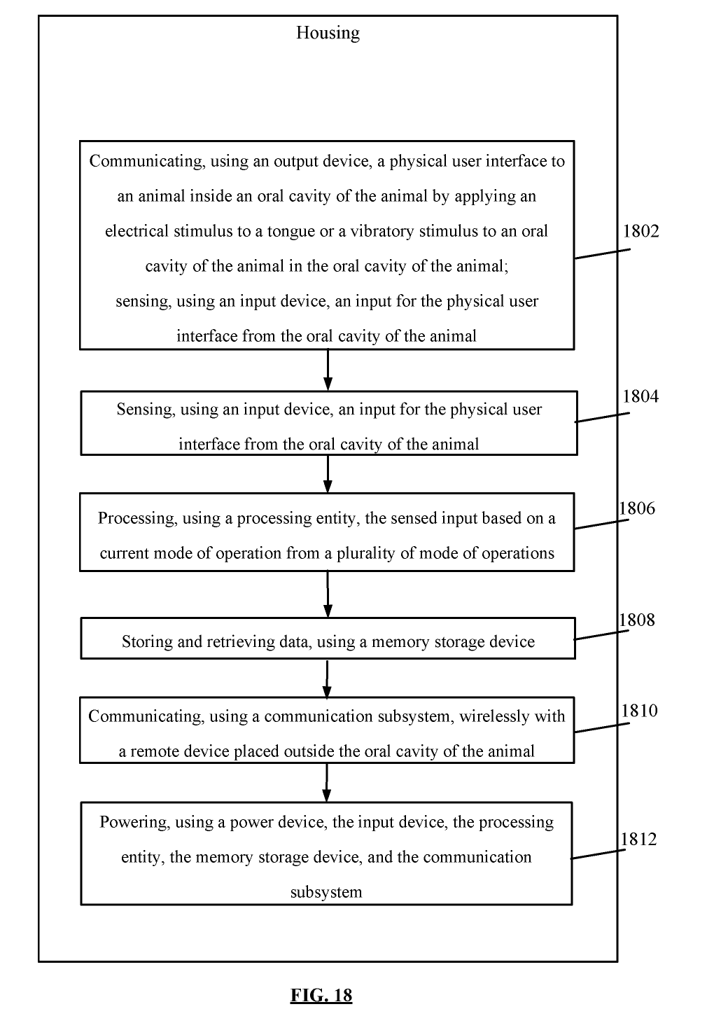

FIG. 18 illustrates a flow diagram for a user interface provided by the device.

The device may use some of the components previously discussed with respect to FIG. 1 and other figures discussed in the specifications. In certain aspects of the disclosure, instructions executing on one or more processors, computing digital and/or analog logic, sensors, power logic, memory, antennae, and several other components discussed previously may be used in performing aspects of the device discussed in more detail below. In certain aspects of the disclosure, a housing resistant to damage from bodily fluids and pressure may be used to encompass the components configured to perform the following steps.

At 1802, components of the device, communicates a physical user interface to an animal inside an oral cavity of the animal. In certain implementations, the device may communicate with the animal by applying an electrical stimulus to a tongue or a vibratory stimulus to an oral cavity of the animal in the oral cavity of the animal. However, such techniques are provided as example and other suitable techniques may also be used. The physical user interface may be a two dimensional (2D) interface, three dimensional (3D) interface, four dimensional (4D) interface or multiple dimensional interface. Each dimension may include one of pressure, vibration, component of position, or component of orientation or any combination thereof. An example 2D interface may include moving the mouse cursor using friction. A 3D interface may include providing the user stereo vibrations throughout the mouth. For example, the one or more vibration motors may be used in providing the user with vibrational input in a 3D space. For instance, the passing of an animal in front of the person may be indicated to the person, by shifting the vibration of the motor in direct correlation with the person passing in front of the as the person using the device. A 4D interface may be generated by providing the vibration to the person in such a way that the vibration not only moves from side to side, but also provides more or less vibrations based on the proximity of the user.

In certain implementations, the multi-dimensional user interface may be further categorized as multi-dimensional input user interface and multi-dimensional output user interface. The multi-dimensional input user interface may include pressure, touch, orientation, location, acceleration, rotation, movement, sound, rotation of two ends of the housing or any combination thereof. In certain implementations, the input device 115 of FIG. 1 may be used in detecting an analog input from an environment of the oral cavity. The multi-dimensional output user interface may include one or more of pressure, vibration, electrical pulse, or electrical shock or any combination thereof. In certain implementations, the output device 120 of FIG. 1 may be used in outputting the stimulus in the oral cavity to the user.

In certain embodiments, the physical user interface may be complemented with one or more logical user interfaces, wherein the logical user interface provides meaning to the input received using the physical user interface.

In certain aspects of the disclosure, the input for the physical user interface may be determined by the processing entity as a command to communicate with a remote device. In certain other aspects of the disclosure, the input for the physical user interface is determined by the processing entity as a command to control a function on the remote device.

In certain embodiments, one or more motion sensors in the input device, may sense a change in orientation of the housing. The device may determine the change in orientation of the housing of the device using motion sensors, such as accelerometers, gyroscopes, magnetometers or any other sensors. Furthermore, the device may determine, using the processing entity, an activity type based on the change in orientation of the housing, and switch the housing into a mode of operation based on the activity type. An activity type may refer to an activity that the user may be engaged in while using the device. For example, the device may determine that the user is running based on the speed, direction, time of the day, location, etc. In another embodiment, the device may determine that the user is driving or is a passenger in the car using at least the reading from the accelerometer. The device may determine that the user is eating based on the motion of the jaw, the sound from the mouth and other changes in the oral cavity.

At 1804, components of the device, such as the input device, senses an input for the physical user interface from the oral cavity of the animal. In certain embodiments, sensing the input may include sensing waveforms at a sensor of the input device, and detecting a pattern associated with the waveform, using the processing entity.

At 1806, components of the device, such as the processing entity, processes the sensed input based on a current mode of operation from a plurality of mode of operations. In some instances, the input itself may switch the device from one mode to another. In some instances, the command is interpreted based on the mode the device is in. The processing entity may first detect an audio signature, a change in orientation signature, a position signature or any combination thereof and then determine the action or command to perform based on the logical user interface associated with the physical user interface based on the current mode of operation.

At 1808, components of the device, such as the memory storage device, stores and retrieves data. At 1810, components of the communication subsystem, communicates wirelessly with a remote device placed outside the oral cavity of the animal. At 1812, components of the power device, powers the processing entity, the memory storage device, and the communication subsystem. Components, such as memory storage devices, communication subsystem and power device are discussed in greater detail with respect to FIG. 1

In certain implementations, the housing may be unanchored in the oral cavity and can be manipulated into a plurality of physical orientations within the oral cavity, similar to device 1040 discussed with reference to FIG. 10. In such an implementation, manipulating the device or housing of the device to a particular orientation may represent a distinct input.

In certain embodiments, components of the device may determine environmental context using input from the input device or communication with the remote device, and switch to a mode of operation based on the determined environmental context. For example, the environmental context may be based on the location of the device. For instance, the mode of operation and/or privacy setting for the device may be different at work and at home, or in a user's home country verses a country the user may be visiting.

What is claimed:

1. A method for providing a user interface, comprising:
communicating, using an output device, a physical user interface to an animal inside an oral cavity of the animal by applying an electrical stimulus to a tongue or a vibratory stimulus to an oral cavity of the animal in the oral cavity of the animal;
sensing, using an input device, an input for the physical user interface from the oral cavity of the animal;
processing, using a processing entity, the sensed input based on a current mode of operation from a plurality of mode of operations;
storing and retrieving data, using a memory storage device;
communicating, using a communication subsystem, wirelessly with a remote device placed outside the oral cavity of the animal;
powering, using a power device, the input device, the processing entity, the memory storage device, and the communication subsystem;
wherein a housing resistant to damage from bodily fluids and pressure comprises the input device, the processing entity, the output device, the memory storage device, the communication subsystem, and the power device.

2. The method of claim 1, wherein sensing the input further comprises:
sensing waveforms at a sensor of the input device; and
detecting a pattern associated with the waveform, using the processing entity.

3. The method of claim 1, further comprising a logical user interface, wherein the logical user interface provides meaning to the input received using the physical user interface.

4. The method of claim 1, wherein the input for the physical user interface is determined by the processing entity as a command to communicate with a remote device.

5. The method of claim 1, wherein the input for the physical user interface is determined by the processing entity as a command to control a function on the remote device.

6. The method of claim 1, wherein the physical user interface is a multi-dimensional interface wherein each of the dimensions comprise one of pressure, vibration, component of position, component of orientation.

7. The method of claim 1, wherein the physical user interface is a multi-dimensional input interface wherein the dimensions comprise one or more of pressure, touch, orientation, location, acceleration, rotation, movement, sound, rotation of two ends of the housing or any combination thereof.

8. The method of claim 1, wherein the physical user interface is a multi-dimensional output interface wherein the dimensions comprise one or more of pressure, vibration, electrical pulse, or electrical shock or any combination thereof.

9. The method of claim 1, further comprising:
sensing, using one or more motion sensors in the input device, a change in orientation of the housing;
determining, using the processing entity, an activity type based on the change in orientation of the housing; and
switching the housing into a mode of operation based on the activity type.

10. The method of claim 9, wherein the activity type is one of driving, talking or eating.

11. The method of claim 1, further comprising:
receiving a command using the user interface;
determining a mode of operation based on the command; and
switching the processing entity into a mode of operation based on the command.

12. The method of claim 11, wherein the command for the physical user interface is detected based on detecting an audio signature, a change in orientation signature, a position signature or any combination thereof.

13. The method of claim 1, wherein the housing is unanchored in the oral cavity and is manipulatable into a plurality of physical orientations within the oral cavity.

14. The method of claim 13, wherein each of the plurality of physical orientations within the oral cavity indicate a distinct input.

15. The method of claim 1, further comprising:
determining environmental context using input from the input device or communication with the remote device; and
switching to a mode of operation based on the determined environmental context.

16. The method of claim 15, wherein determining the environmental context is based on determining location of the housing.

17. An apparatus comprising:
an oral retainer anchored in a mouth of an animal and resistant to damage from bodily fluids and pressure and further comprises:
an input device sensing an input from a user;
a processing entity communicatively coupled with the input device and configured to process input from the input device;
an output device communicatively coupled to the processing entity, wherein the output device communicates a user interface to the user by applying a stimulus to the mouth;
a memory storage device communicatively coupled to the processing entity, wherein the memory storage device stores and recalls data;
a communication subsystem coupled to the processing entity, wherein the communication subsystem communicates with a remote device placed outside the mouth of the animal; and
a power device powering the input device, the processing entity, the output device, the memory storage device, or the communication subsystem.

18. The apparatus of claim 17, wherein the oral retainer fits against the teeth of maxilla.

19. The apparatus of claim 17, wherein the oral retainer fits against the oral palate.

20. The apparatus of claim 17, wherein the oral retainer fits against the teeth of the mandible.
